(19) United States
(12) Patent Application Publication
(10) Pub. No.: US 2026/0098426 A1
(43) Pub. Date: Apr. 9, 2026

(54) LOCKER ASSEMBLY AND INSTALLATION

(71) Applicant: Zephyr Lock, LLC, Newtown, CT (US)

(72) Inventors: Patrick Wind, Darien, CT (US); Kevin Houlihan, North Salem, NY (US); Timothy Marshall, Wolcott, CT (US)

(21) Appl. No.: 19/349,025

(22) Filed: Oct. 3, 2025

Related U.S. Application Data
(60) Provisional application No. 63/702,787, filed on Oct. 3, 2024.

(51) Int. Cl. E05B 65/02; G06F 16/22

(52) U.S. Cl. CPC E05B 65/025; G06F 16/22

(57) ABSTRACT

A process for installing lockers includes manufacturing a plurality of combination locks, wherein each combination lock includes a first scannable feature. The locks are installed in multiple locker assemblies. The locker assemblies each include a second scannable feature uniquely identifying the locker assembly. Each combination lock is associated with a corresponding unique serial number and unique combination. The unique serial numbers and unique combinations are stored in a database. The locker assemblies are provided to a locker installer and the locker installer installs the locker assemblies in a location. The first scannable feature is scanned using a scanner and a unique indicia of the combination lock is identified using the first scannable feature. A control chart is created by providing a scanner output to a remote computer system storing the database. The control chart associates each locker with a combination of the combination lock installed in each locker.

### CROSS REFERENCE TO RELATED APPLICATIONS

This application claims the benefit of the following U.S. Provisional Patent Application: Ser. No. 63/702,787 filed Oct. 3, 2024, the contents of which are incorporated herein by reference thereto.

### INTRODUCTION

The subject disclosure relates to a locker assembly and manufacturing processes, and in particular to a system and process for increasing efficiency of locker assembly and installation.

Locker assemblies for schools, gyms, and other areas where large numbers of people will be sharing a space often include integrated combination based locks with each locker having a lock with a unique combination, or multiple combinations, required to unlock the locker. In such cases, the lockers and the incorporated locks are manufactured separately and provided to an installer who installs the lockers and the locks in a space.

As the locks each include a unique combination, which lock is installed in which locker, and where that locker is in a given area, should be tracked in order to know what the combination is for a given locker. This tracking is typically achieved by laying the locks out sequentially near, or on, the installed locker with the installer using a first lock from a first box for the first locker, a second lock from the first box for a second locker, etc. As the locks are installed, the installer is responsible for creating a combination chart for the lockers that includes each locker identifier (e.g., numbers, letters, or any other suitable indicia), the location of the locker, and the corresponding lock combination. The chart of locker numbers, locations, and combinations is referred to as a control chart.

The steps in this process requiring the locks to be maintained in a specific order increases the installation time and is prone to human error. In addition, efficiency of the installation is improved, reducing resources required to be expended on-site during installation.

Accordingly, it is desirable to provide a system and process for installing locker systems that allows for efficient installation and minimizes potential human errors.

### SUMMARY

A process for installing lockers includes manufacturing a plurality of combination locks, wherein each combination lock includes a first scannable feature. The locks are installed in multiple locker assemblies. The locker assemblies each include a second scannable feature uniquely identifying the locker assembly. Each combination lock is associated with a corresponding unique serial number and unique combination. The unique serial numbers and unique combinations are stored in a database. The locker assemblies are provided to a locker installer and the locker installer installs the locker assemblies in a location. The first scannable feature is scanned using a scanner and a unique indicia of the combination lock is identified using the first scannable feature. A control chart is created by providing a scanner output to a remote computer system storing the database. The control chart associates each locker with a combination of the combination lock installed in each locker.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates an example locker installation; and

FIG. 2 is a process for assembling and installing the locker of FIG. 1.

### DETAILED DESCRIPTION

The following description is merely exemplary in nature and is not intended to limit the present disclosure, its application or uses. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein smart components refer to elements or components of a system, such as a combination lock, that utilize a computer processor to perform computations and/or enact computer processes.

To save money and gain efficiency in the supply chain of the lock manufacturing and the assembly process of lock installation the system disclosed herein generally operates by manufacturing combination locks and providing the combination locks to a locker manufacturer. Each combination lock includes a scannable serial number. The locker manufacturer then installs the locks on locker doors as part of the locker assembly. The installation of the locks on the locker doors may be done in any order of locks regardless of the order in which the locks were initially packaged. In some examples, the locker assembly is a fully assembled locker. In other examples, the locker assembly is a locker door ready to be installed on cabinetry or assembled lockers on site. Due to the scannable serial number, the locker manufacturer does not need to track which lock is installed in which locker and the control chart can be constructed after the lockers have been fully assembled and installed.

In one example, fully assembled lockers or locker doors, including the combination locks, are provided to a job site where lockers are being installed and the lockers are installed. Again due to the scannable serial numbers, no particular order or tracking of the lockers needs to be maintained during the installation process.

Once the lockers are installed, the installer scans each locker using a scanner that records the room or area in which the locker is positioned, the locker number assigned to the locker being scanned, and the serial number of the lock. The scanner connects to a database storing lock serial numbers and combinations corresponding to the specific serial numbers. The database may be stored locally, remotely accessed via an online interface, or in any other accessible configuration. A software module within the scanner, or connected to the scanner, then creates or updates a control chart identifying the correct lock, locker number, location and combination information for the area.

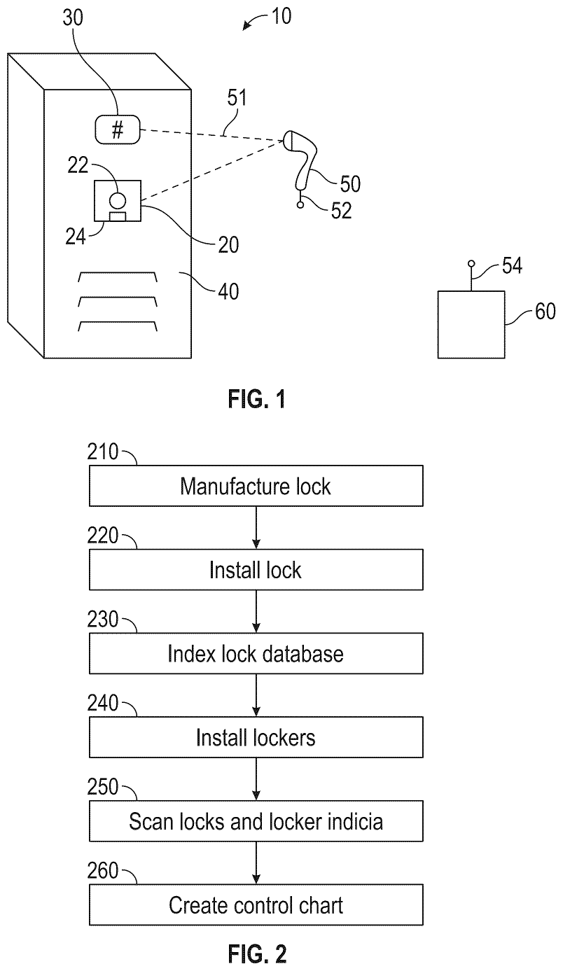

With continued reference to the general system described above, FIG. 1 illustrates a locker 10 assembly. The locker 10 includes a lock 20. In some examples (e.g., metal lockers) the locker 10 includes a lock cup in which a combination lock 22 is installed. A scannable feature 24 is embedded in or on the combination lock 22. A locker identifier 30 is affixed to, or otherwise inscribed on, the locker door 40. The locker identifier 30 is also scannable and may be located at any position on the locker door 40 including, but not limited to, an exterior facing surface of the door 40 and an interior facing surface of the door 40. In some examples, such as those where the identifier 30 includes a radio frequency identification (RFID), the identifier 30 may be interior to the structure of the door 40. The scannable feature 24 is, in one example, an image or alphanumeric key. The image or an encrypted alphanumeric sequence can be decoded into the serial number of the combination lock 22 using a key. In some examples, the key is an encryption key. In other examples, the key is an algorithm configured to interpret the image or alphanumeric key. In some examples, the image is a scannable image format, such as a barcode or a QR code.

In yet another example, the scannable feature is a broadcast signal such as a radio frequency identification (RFID) signal from an embedded RFID chip. In such an example, a scanner 50 reads the signal provided from the RFID chip and interprets the signal into an encoded serial number. Further, in such examples, the broadcast signal is not integrated into the lock mechanism itself and the combination lock 22 does not include smart components.

The scanner 50 is a handheld scanner and includes one or more internal sensors for generating an image of an object within a viewing zone 51 of the scanner 50. The scanner 50 includes a connection 52 to an external computer system 60. The external computer system 60 includes a database correlating serial numbers of the locks 22 to unique combinations for unlocking the specific lock 22 and a connection 54 for connecting to the scanner 50.

The connections 52, 54 can be wireless or wired. In examples where the connection is wired, the scanner 50 includes an internal memory. The internal memory is able to store multiple lock 22/locker identifier 30 scans and provide each scan to the database 60 when the connection 52, 54 are connected to each other.

With continued reference to the locker 10, FIG. 2 illustrates an example process for manufacturing and installing the locker 10. Initially, the combination lock 22 is manufactured in a manufacture lock step 210. The combination lock 210 is in one example a tumbler style combination lock with no internal smart components. Each lock 22 manufactured during the manufacture lock step 210 includes a unique serial number, or other unique identifier, that can be retrieved from the scannable feature.

Once manufactured, the locks 22 are installed in a locker door 40 assembly (such as the locker door 40 of FIG. 1) in an install lock step 220. In one example, the locks 22 are installed by an installer who is installing the locker assemblies 10. In an alternate example, the locks 22 may be installed into the locker door 40 immediately after the locks are manufactured at step 210. In the alternate example, the lock manufacturer assembles and installs the locks 22 into the locker door 40 and the assembled locker doors 40 are provided to the installer.

Each assembled lock is indexed by serial number into a database in an index lock database step 230. The database is then uploaded to a manufacturer's computer system, and can be accessed during locker installation. The database includes all information necessary to create a control chart.

The indexed locks and/or locker doors 40 are then provided to an installer who is able to assemble full lockers 10 or locker doors 40 and the lockers are installed in an install lockers step 240.

Once the lockers are assembled and installed, the installer scans each lock and locker indicia in order, in a scan locks and locker indicia step 250. The data collected by the scanner 50 is provided to the external computer system 60 either as each locker 10 is scanned (in the case that the scanner 50 is wirelessly connected to the external computer system 60) or after the full scan locks step 250 is completed.

While described in a particular order for explanatory purposes, it is appreciated that the features may be scanned in any order depending on the particular conditions and circumstances of a given implementation.

After completing the scans in the scan locks step 250, the external computer system 60 creates a control chart in a create control chart step 260. The created control chart 260 defines the locker combination for each locker and is provided to the operator of the facility in which the lockers were installed.

In some examples, the scan locks and locker indicia step 250 and the create control chart step 260 may be modified to utilize an express scan process where the lockers 40 are scanned in a preset order (e.g. ascending numerical order, alphabet order, etc.), and only the lock 20 itself is scanned. As the locks 20 are scanned, the corresponding combinations are populated into the next control chart entry. The express scan modification may be utilized in configurations where there is no overlapping (or partially overlapping) indicia for lockers 40.

In an embodiment, the control chart is generated using one or more controllers. The controllers may be local to the scanner, disposed at a remote computing system, or a combination thereof. The controller may include memory to store instructions that are executed by one or more processors. The executable instructions may be stored or organized in any manner and at any level of abstraction, such as in connection with a controlling and/or monitoring operation of the creating the control chart including but not limited to interpreting the scanned indicia, indexing locks, and associating locks and/or lockers with at least one corresponding combination for unlocking the locks and/or lockers.

The one or more processors can be any type of central processing unit (CPU), including a general purpose processor, a digital signal processor (DSP), a microcontroller, an application specific integrated circuit (ASIC), a field programmable gate array (FPGA), or the like. Also, in embodiments, the memory may include random access memory (RAM), read only memory (ROM), or other electronic, optical, magnetic, or any other computer readable medium onto which is stored data and control algorithms in a non-transitory form.

Implementation of the systems and processes described herein can reduce a need for custom orders and increase the efficiency of manufacturing and assembly, as well as the efficiency of installation of lockers. In addition, the system described can facilitate the distribution of inventory by removing the need to track individual locks all the way until an end installation.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A process for installing lockers comprising:
manufacturing a plurality of combination locks, wherein each combination lock includes a first scannable feature;
installing the locks in a plurality of locker assemblies, wherein the locker assemblies each include a second scannable feature uniquely identifying the locker assembly;
associating each combination lock with a corresponding unique serial number and unique combination and storing the unique serial numbers and unique combinations in a database;
providing the locker assemblies to a locker installer, installing the locker assemblies in a location;
scanning the first scannable feature using a scanner and identifying a unique indicia of the combination lock using the first scannable feature ; and
creating a control chart associating each locker with a combination of the combination lock installed in each locker by providing a scanner output to a remote computer system storing the database.

2. The process of claim 1, wherein each combination lock is characterized by a lack of integration with smart components.

3. The process of claim 1, wherein the scannable feature is one of an image and an encrypted alphanumeric sequence.

4. The process of claim 3, wherein the scanner includes a key configured to interpret the one of the image and the encrypted alphanumeric sequence.

5. The process of claim 3, wherein the scannable feature is a scannable image format.

6. The process of claim 1, wherein the scannable feature is a broadcast signal.

7. The process of claim 1, wherein providing the locks to a locker installer and installing the locks in a location comprises providing fully assembled lockers to the location with each locker including one of the locks.

8. The process of claim 1, wherein providing the locks to a locker installer and installing the locks in a location comprises providing a plurality of locker door to the location, with each locker door in the plurality of locker doors including a corresponding lock.

9. The process of claim 1, wherein a specific ordering of locks is not maintained through the process.

10. The process of claim 1, wherein the locker assembly is one of a full locker and a locker door.

11. The process of claim 1, wherein manufacturing the plurality of combination locks includes installing the combination locks in locker cups, and wherein the first scannable feature is included on one of the combination lock and the locker cup.

12. The process of claim 1, further comprising scanning the second scannable feature using the scanner and identifying the locker assembly using the second scannable feature, and associating the locker assembly with a corresponding combination lock using the scans of the first scannable feature and the second scannable feature.

13. A process for installing lockers comprising:
manufacturing a plurality of combination locks, wherein each lock includes a first scannable feature;
installing the locks in locker assemblies, wherein each locker assembly includes a second scannable feature uniquely identifying the locker assembly;
associating each combination lock with a corresponding unique indicia and unique combination and storing the unique indicia and unique combinations in a database;
providing the locker assembly and the plurality of combination locks to a locker installer, installing plurality of combination locks in corresponding locker assemblies and installing the locker assemblies in a location;
scanning the first scannable feature using a scanner and identifying a unique indicia of the combination lock using the first scannable feature; and
creating a control chart associating each locker with a combination of the combination lock installed in each locker by providing a scanner output to a remote computer system storing the database.

14. The process of claim 13, wherein each combination lock is characterized by a lack of integration with smart components.

15. The process of claim 13, wherein the scannable feature is one of an image and an encrypted alphanumeric sequence.

16. The process of claim 15, wherein the scanner includes a key configured to interpret the one of the image and the encrypted alphanumeric sequence.

17. The process of claim 15, wherein the scannable feature is a scannable image format.

18. The process of claim 13, wherein the scannable feature is a broadcast signal.

19. The process of claim 13, wherein a specific ordering of locks is not maintained through the process.

20. The process of claim 13, wherein the locker assembly is one of a full locker and a locker door.
